(19) United States
(12) Patent Application Publication
(10) Pub. No.: US 2017/0314320 A1
(43) Pub. Date: Nov. 2, 2017

(54) INSTALLATION DOOR FRAME

(71) Applicants: Frank Giuliani, Toronto (CA); Marco Antonio AVOLA, Toronto (CA); Rafael Albuquerque Loureiro FERREIRA SILVA, Hamilton (CA)

(72) Inventors: Frank Giuliani, Toronto (CA); Marco Antonio AVOLA, Toronto (CA); Rafael Albuquerque Loureiro FERREIRA SILVA, Hamilton (CA)

(21) Appl. No.: 15/497,729

(22) Filed: Apr. 26, 2017

Related U.S. Application Data
(60) Provisional application No. 62/328,886, filed on Apr. 28, 2016.

(51) Int. Cl. E06B 1/52; E06B 1/32; E06B 1/26; E06B 1/20; E06B 1/10; E06B 1/60; E04F 21/00

(52) U.S. Cl. CPC E06B 1/52; E06B 1/6015; E06B 1/325; E04F 21/0015; E06B 1/20; E06B 1/10; E06B 1/26

(57) ABSTRACT

The present invention provides a door frame comprising of two piece units and the method of installment to provide connection between the casing and the frame with a self-alignment system. This is done by a tongue and groove connection and plurality of prefabricated dowels that are specially formed to engage the grooves provided in the frame through the entire attachment area of the frame units together. The door frame units are being assembled and secured together by providing a solid reinforced assembly. In the door frame system of the present invention a strong square joint can be produced by inserting dowels at critical joints which is significantly stronger fastening mechanism than other fastening means such as nails, staples, etc. Low expansion reinforced foam fills the cavities of the frame and creates a solid bond between door system and casing.

### FIELD OF THE INVENTION

The present invention is a prefabricated door frame assembly and a method of installation for the same.

### BACKGROUND OF THE INVENTION

In order to reduce labor costs and time required to construct buildings such as homes and offices, various building mechanisms or assemblies, such as door assemblies, are prefabricated. Prefabrication avoids the need to transport many materials and skilled workers to the construction site, therefore, reducing time and cost.

The prior art related to the prefabricated door assemblies discloses a partially assembled door frame. In order to fit the door frame within an irregular opening in a wall panel, casing members are generally supplied separately and are placed in the door opening. A certain amount of labor time is needed in order to properly mount the casing members. Once the casing and frame are set, the door is hung in its frame.

A typical prefabricated door takes approximately 60-90 minutes for a skilled carpenter to install and involves shimming and attaching the door jamb to wall studs, attaching trim around the door opening to hide the gap between the jamb and the wall, and finally hinging the door to the jamb.

There is a demand for more simplified and more economical building materials, components and techniques. One particular segment of the increased volume, which has exhibited widespread growth, is the field of home improvement where carpenters and builders seeking easier and foolproof procedures reducing time accomplish a great deal of the work and thus, reducing cost. In response to such demands, various modular door and frame assemblies, in which a good deal of the operations that require more skilled and specialized tools, are completed in the factory, leaving only less complex procedures to the installer in the field.

The present invention provides a door assembly, which is completely prefabricated and does not require professionals to install the door frame and is basically a self-installing system.

### SUMMARY OF THE INVENTION

The present invention is a completely prefabricated doorjamb system that is easy to install, takes less time to install, and does not require professionals for installation.

The present invention provides a door frame comprising of two split units that are joined together forming a single frame, and a method of installment of the door frame on the wall opening. The present system has a tongue and groove connection means for self-alignment of the two split units. In addition, separate elements of each split unit are glued together and enhanced with a plurality of prefabricated dowels provided in the frame through the entire attachment area of the frame units. Strong square joints are produced by inserting dowels at critical joints. This provides a significantly stronger fastening mechanism than other fastening means such as nails, staples, etc.

The door frame split units are attached to each other and to the wall opening using foams, glues or any other adhesives. Low expansion reinforced foam fills the cavities of the frame and creates a solid bond between door system and the wall. Traditional method of attachments, like using nails and screws, can also be used to attach the frame to the wall.

The present invention does not require any attachment mechanism to support the door or tools for installation. It allows an unskilled laborer to install an interior door in a significantly less time than that required for installation of a conventional pre-hung door by a skilled carpenter. The tongue and groove alignment system makes it possible to install the door frame on varying wall dimensions with variation up to 0.75 inches to accommodate different drywall thickness and imperfections in the walls. There is no need for the installer to fasten the jamb to the wall or to square the legs and head of the jamb.

It is the first objective of the present invention to provide a Complete Factory Finish door system. The installation system can be used by the home owners, to install their doors by themselves in a quick, easy and inexpensive way. It is a completely preassembled unit which stays securely in place and retains the integrity of its connecting joints by itself.

It is the second objective of the present invention to provide a Self-Installing door system, which does not require a skilled worker for installation.

It is another objective of the present invention to provide a door frame installation system which reduces the installation time and labor cost. The presently disclosed door system can be installed within 15 minutes, whereas the other prefabricated door frames may take an hour or more to complete.

It is another object of the present invention to provide a stronger, tighter and more solid connection between different elements of the door assembly.

Other objects, features, and advantages of the present invention will be readily appreciated from the following description. The description makes reference to the accompanying drawings, which are provided for illustration of the preferred embodiment. However, such embodiments do not represent the full scope of the invention.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 is a perspective view of a free standing, prefabricated door/jamb assembly according to the present invention;

FIG. 2 is a perspective view of the bottom portion of the door frame;

FIG. 3 is a perspective side view of the front frame and back frame joint;

FIG. 4 is a perspective view of the bottom of the front (female) frame;

FIG. 5 is a perspective view of the bottom of the back (male) frame;

FIG. 6 is a cross sectional view of a corner of the door frame;

FIG. 7 is a bottom view of the door frame assembly and the door installed thereon;

FIG. 8 is a partial perspective view of the door frame assembly and the door installed thereon;

FIG. 9 is a sectional view of the first step of the installation of the frame on the wall opening;

FIG. 10 is a sectional view of the second step of the installation of the frame on the wall opening;

FIG. 11 is a sectional view of the third step of the installation of the frame on the wall opening;

FIG. 12 is a sectional view of the fourth step of the installation of the frame on the wall opening;

FIG. 13 is a sectional view of the fifth step of the installation of the frame on the wall opening;

FIG. 14 is a sectional bottom view of a complete frame installed on the wall opening, and

FIG. 15 is a front view of the upper corner of the frame.

### DETAILED DESCRIPTION OF PREFERRED EMBODIMENTS

The figures are not intended to be exhaustive or to limit the present invention to the precise form disclosed. It should be understood that the invention can be practiced with modification and alteration, and that the disclosed technology be limited only by the claims and equivalents thereof.

The invention disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

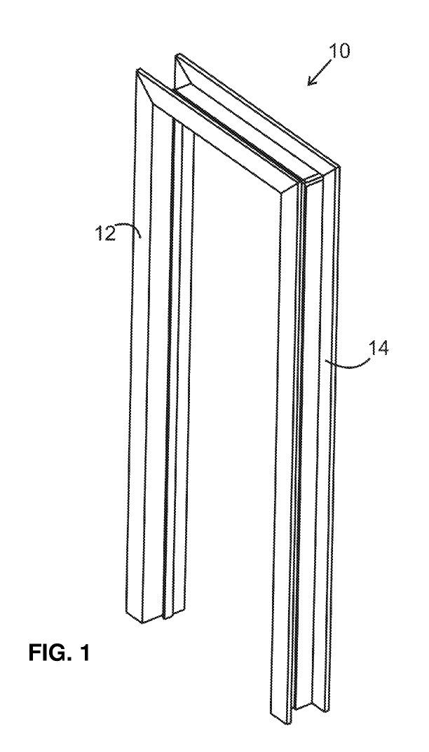

FIGS. 1, 2 and 3 shows a prefabricated door frame unit 10 ready to be installed into an opening in the wall. The door frame unit 10 is fully pre-assembled. The door assembly 10 is comprised of two pieces of prefabricated U shape frames, 12 and 14, each having an L shape cross section. A front (female) frame 12 and a back (male) frame 14. The cross sections of the frames 12-14 comprise of a door jamb 12a and 14a, and a side casing 12b and 14b. The door jambs 12a and side casing 12b of the front frame 12 are connected to each other to build the L shape cross section door frames 12. Similarly, and the door jamb 14a and the side casing 14b of the back frame 14 are connected to each other to build the L shape cross section door frames 14. Connecting the two L shape sections 12 and 14 will result in a U shaped cross section. The door jambs 12a-14a comprise of a pair of vertical side legs 16-18 and a horizontal first header units 17, 19 crossing the upper ends of the side legs 16-18. The side casings 12b-14b further comprise of vertical legs 22-24 and a horizontal casing header 25 crossing the upper ends of said vertical legs 22-24. The frame units 12-14 are manufactured in any desirable length and in one-piece construction or the side casings and the door jambs can be manufactured in two separate pieces and connected together on installation site by dowel means.

The side legs 16 and the first header 17 of the front frame 12, and the side legs 18 and the second header 19 of the back frame 14 are sized to fit in the doorway and be securely maintained in a parallel relationship to each other and in a perpendicular relationship to the headers 17, 19.

The upper ends of the vertical legs 22-24 of casings 12b-14b are squarely connected to the opposite ends of the casing header 25 in a distance from the top of the vertical legs 22-24 with a dimension equal to the width of the side casing keeping the L shape of the frame.

The front frame door jamb 12a has an inner edge 12c having a cut at a right angle (90 degrees) on its top surface to build an longitudinal tongue trim extending all-around the inner edge 12c of the door jamb 12a.

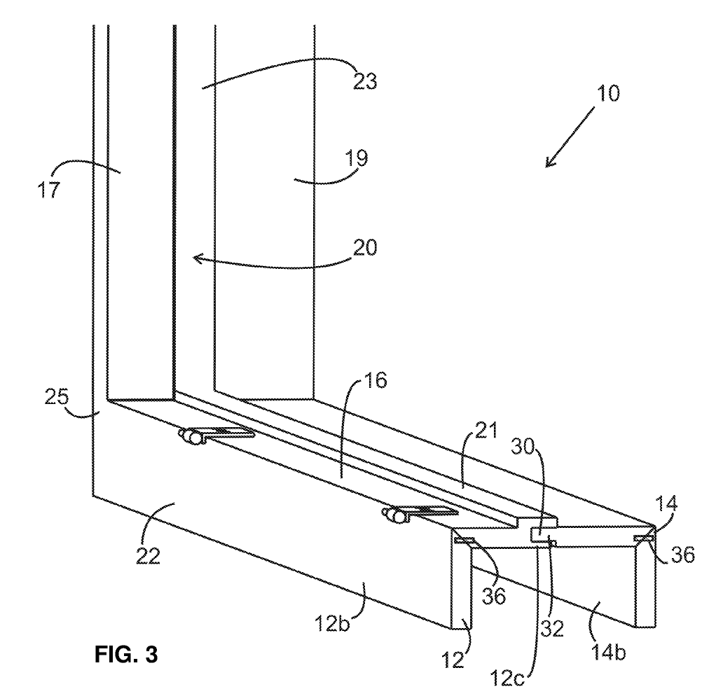

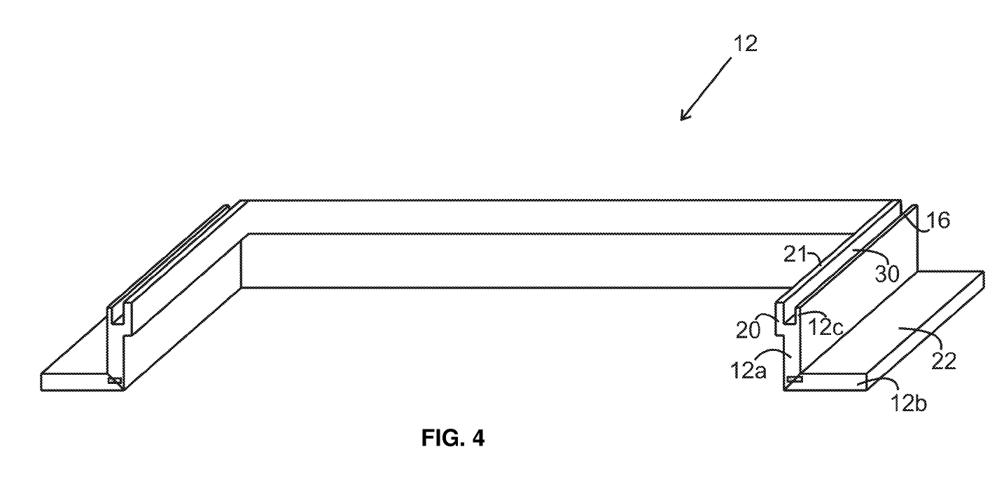

According to FIGS. 3 and 4 a door stop 20 is attached to the inner side of the front frame 12. The door stop 20 includes vertical legs, 21 and top piece 23 crossing the upper end of the vertical legs 21. Each of vertical legs of the door stop 21 form a square butt-end joint with top piece 23. The door stop 20 is sized to fit on top surface of the front frame 12 and is attached on the front frame door jamb 12a close to its inner edge 12c in a manner that each door stop vertical leg 21 builds a groove 30 on the inner edge of the front door jamb 12c.

FIG. 4 is a view of the bottom 11 of the front frame 12 showing an elongated groove 30 formed in one edge of the front frame 12 extending all-around said edge. The grooved edge is a rectangular groove 30 having a planar lower surface 15 with a length same as the planar lower surface of the tongue in the back frame 14 and will engage to the back frame 14. The groove is moulded so that a vertical leg 21 of the door stop 20 and a vertical leg 16 of the front frame 12 build the groove slot 30. The inner side of the door stop legs 21, 22 build one angle of the groove which is preassemble glued or curved to the inner side of the front frame 12 facing the door opening 31.

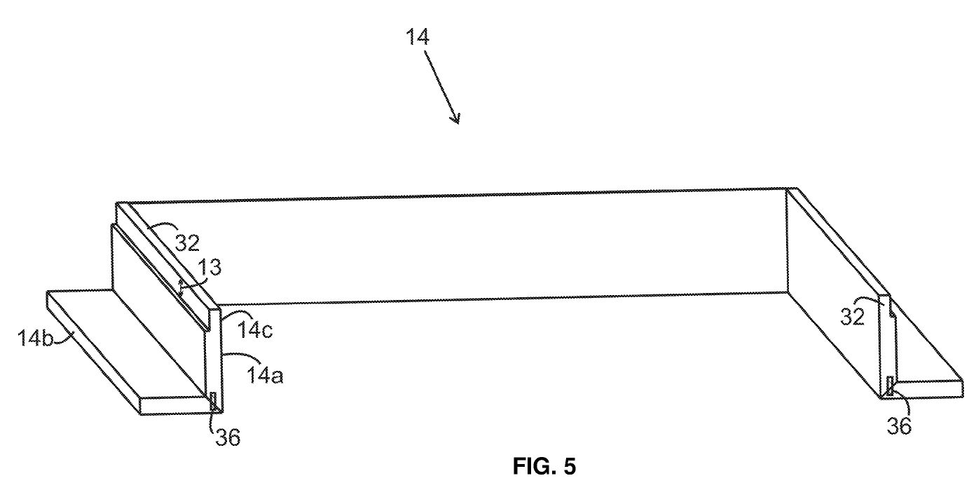

FIG. 5 is a view of the bottom of the back frame 14 showing an elongated tongue 32 formed on inner edge 14c of the door jamb 14a of the back frame 14 extending all-around the edge 14c. The tongue is a rectangular cut 32 from its bottom surface to build a longitudinal tongue trim 32 having a planar lower surface 13 with a length same as the planar lower surface of the groove 30 in the front frame 12. The tongue trim 32 extends all-around the inner edge of male door jamb 14c.

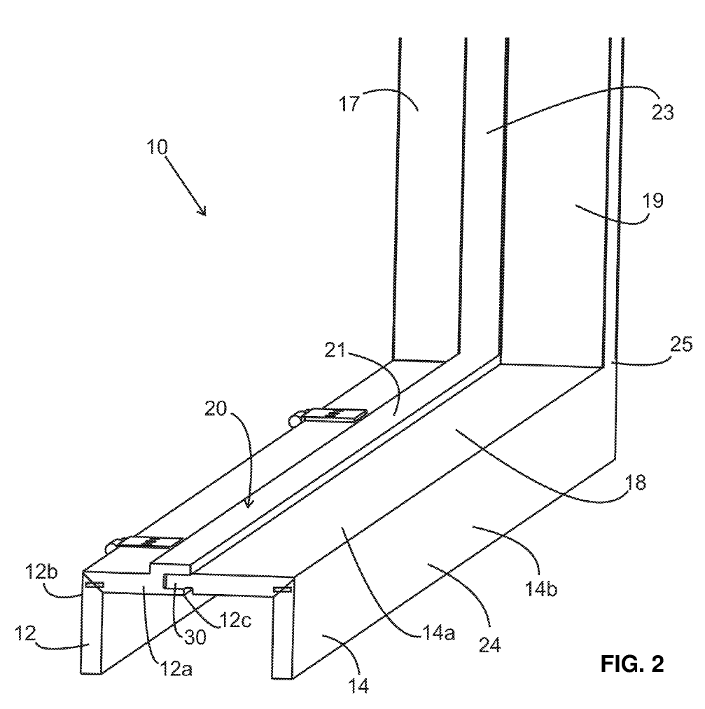

As shown in FIGS. 2 and 3 in installation the longitudinal tongue 32 of the back male frame 14 being received by the longitudinal groove 30 of the female frame 12 so that the front frame 12 and the back frame 14 being connected to each other securely. The tongue-and-groove units will join by projecting the front frame 12 to the front side of the doors opening and fit the back frame 14, edge to edge, and allow two pieces 12, 14 to be joined strongly together to make a single frame unit 10 and providing substantial structural strength of the frame parallel to the wall.

According to FIGS. 1-8 plurality of dowel joints 36 in critical joinders are provided to support and maximize strength and rigidity of the frame

The door frame unit 10 of the present invention is manufactured in two split units 12 and 14, with a standard dimension and are adjustable up to 0.75 inches in depth. This allows for the installment of the present door assembly into a wide range of drywall thicknesses and imperfections in the wall. Therefore, there is no need to custom cut the door frame to a particular door opening, providing a custom fit door without customization. The prefabricated doors may be made from different types of wood, plastic, steel, fibreboard, or any other types of suitable material, and come in different colours and shades.

The present door frame is prefabricated and ready for installation. In such prefabricated frames, the structural strength is critical. Therefore, it is important to use strong material, which provides sufficient lateral stability and resistance to shear forces in either direction. For this purpose, layers of plywood board are moulded and glued together to build a strong door frame with a tongue and groove attachment means. The tongue (male unit) fits the groove (female unit) tightly holding the two parts of the frame together.

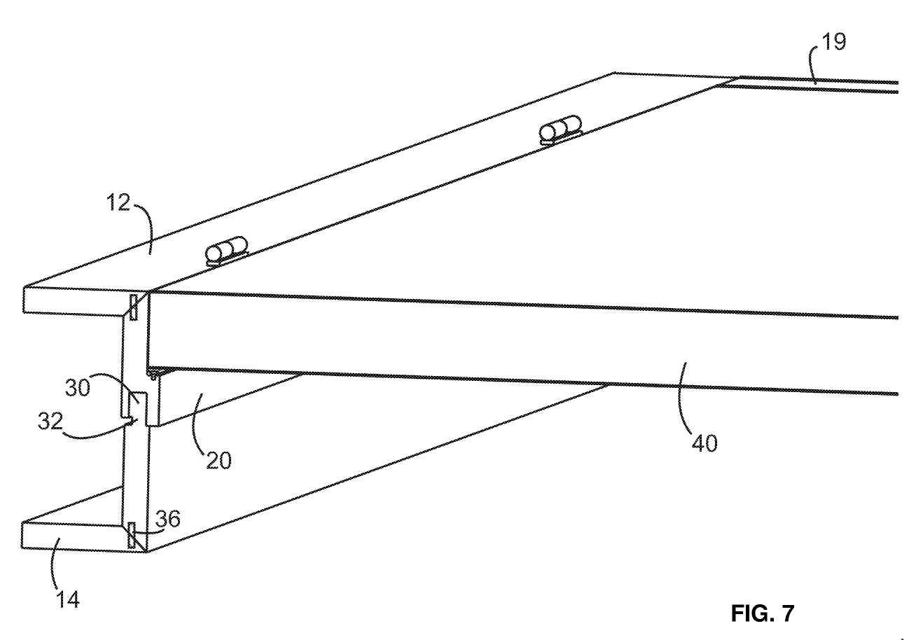

FIG. 7 shows the assembled door frame 10 from bottom side illustrating important refinements of the invention which shows the joint of the front frame 12 and back frame 14 to each other and create a door frame that is sufficiently rigid to support a door 40 without anchoring the frame to the wall. Said two adjacent frame units 12, 14 are connected together with a tongue-and-groove joint 30, 32 said tongue-and-groove joint being formed by projecting the front frame 12 to the front side of the doors opening and fit the back frame 14, edge to edge, and allow two pieces 12, 14 to be joined strongly together to make a single frame unit 10 and providing substantial structural strength of the frame parallel to the wall. Plurality of dowel means 36 are provided to support and secure the units 12, 14 in relation to each other. It is determined that combination of dowels 36 and tongue and groove joint are used in critical joinder to maximize strength and rigidity to the frame.

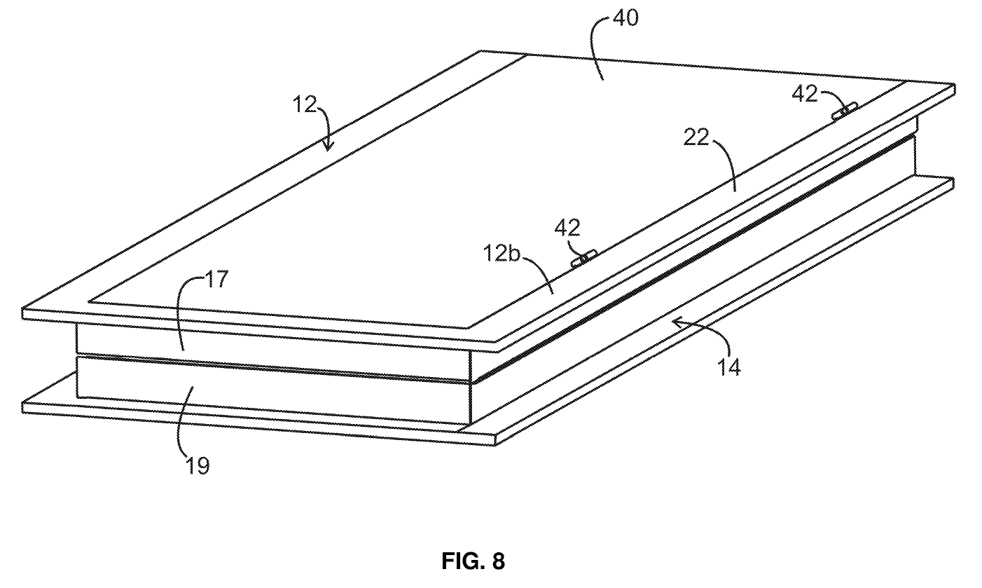

FIG. 8 is a sectional view of the assembled door frame 10 from its top. Dowels 36 secure corner joints. A door 40 is attached via hinges 42 to the Front frame 12. The door is hinged to the vertical leg 22 of the side casing 12b of the front frame 12. In order for a door frame to be strong enough to support a door without attachment to the wall, it is important that the corners be square, and the mechanism of the joint be strong enough to keep the structure of the door by daily pressures. The corner edges are secured together by the dowel pins 36. The dowels 36 are intended to be formed therein by compression, in which a portion of the dowel is inserted and secured. The tongue and groove alignment system makes it possible to install the door frame 10 on varying wall dimensions with variation up to 0.75 inches to accommodate different drywall thickness and imperfections in the walls. There is no need for the installer to fasten the door frames to the wall or to square the legs and head of the frames.

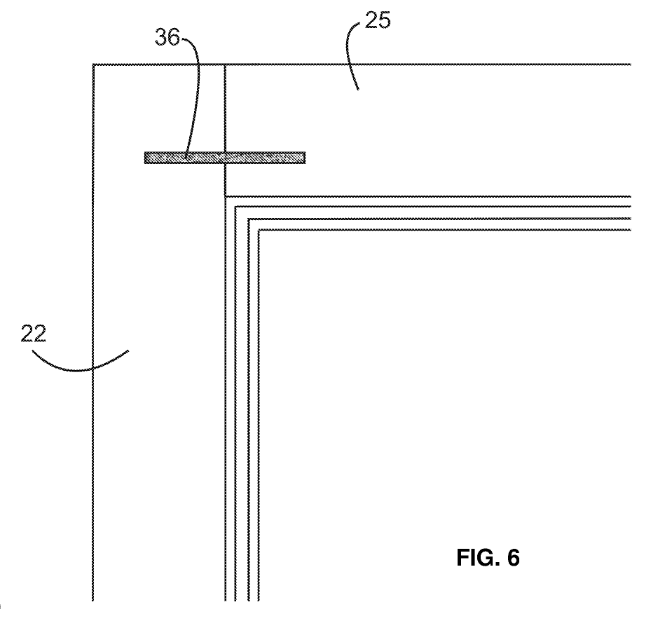

According to FIGS. 6, 7 and 8, again each of the side legs of the front frame 12 and side legs of back frame 14 are securely maintained in a parallel relationship to each other and in a perpendicular relationship to the headers 17 and 19 to form rigid metered corner joints. Corner joints are secured by dowels 36. The corner sections are connected to one another, so that each frame part at the corner has a dowel extending outwardly thereof, and the corresponding frame member has an opening wherein the dowel extends into the depth of the opening by providing a force to securely connect the two corner joints to one another. The dowel members 36 insert completely into the depth of the corresponding frame corner and for engaging two corners a pressure force engagement is used to join the corners rigidly.

The frame units 12 and 14 are usually being formed of wood boards but they may be formed of any suitable material. The board is fed through a grooving machine and adhesive preparation is inserted to make a firm, secure and supportive joints.

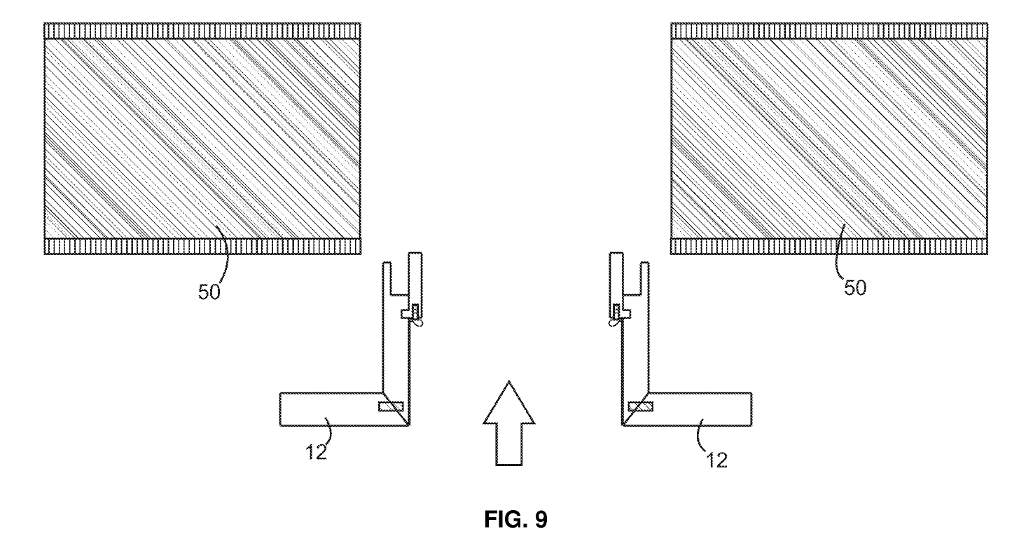

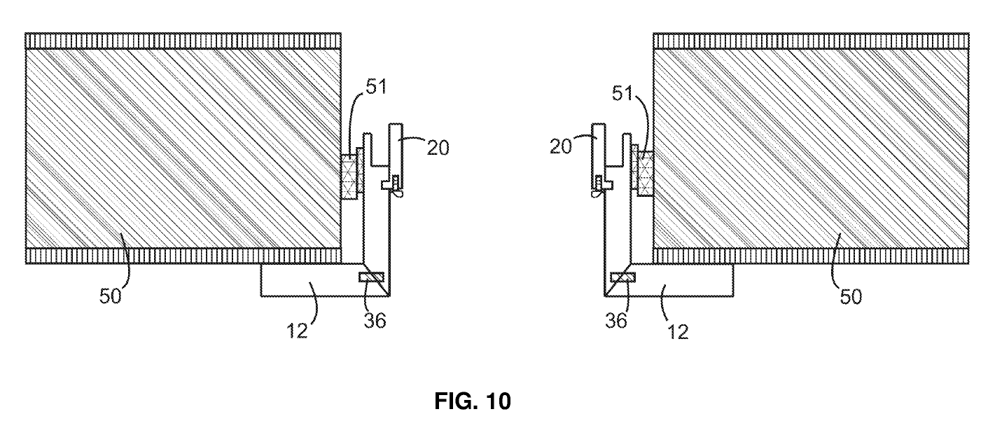

FIGS. 9 to 15 disclose the assembly steps of the front frame 12 and back frame 14 for joining and being mounted to the door opening. In the first step as shown in FIG. 9 the front frame (groove unit) 12 is mounted on the wall 50. Usually adjustment to the guides as shown in FIG. 10 step 2, is done by inserting thin shims 51 between the frame units 12 and the wall 50 to align and make them fit.

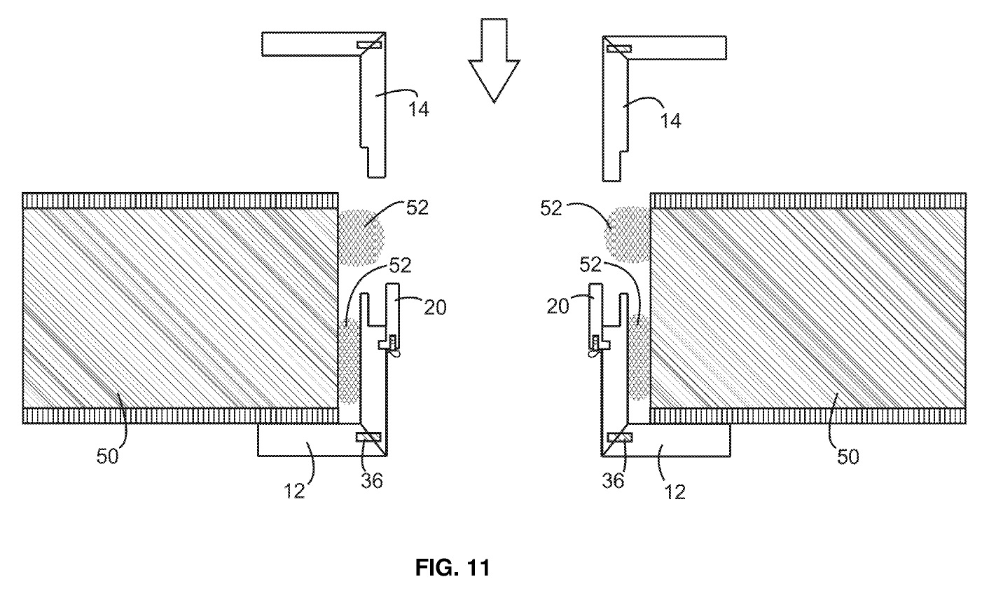

FIG. 11 step 3 shows the step of the joint of the frame units 12 and 14 in which foam 52 is applied between wall 50 and the frame units 12 and 14 to fill the gaps. The reinforced foam 52 provides strong resistance to forces exerted to the frame such as the forces applied to the frame by a door in the closed position. It is desirable to let for approximate 10-15 minutes to dry and then place the back frame (tongue unit) 14. The tongue and groove units are moulded such that the tongue is fully inserted in to the groove and are cut in a standard dimension to have maximum width of the wall.

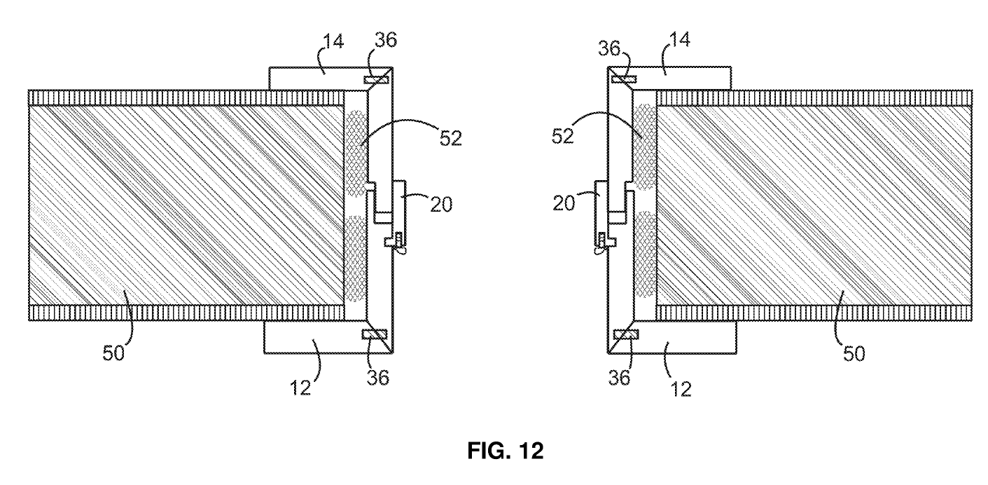

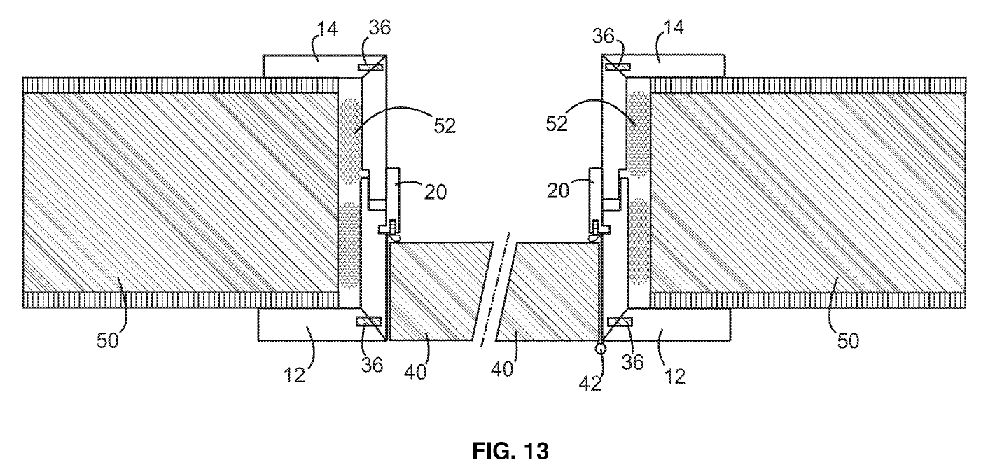

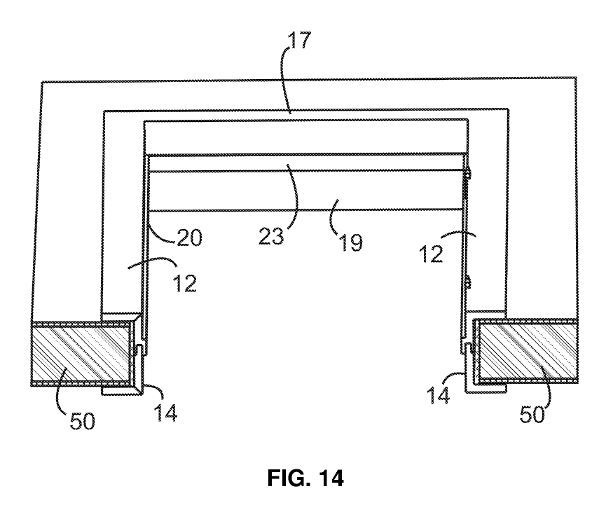

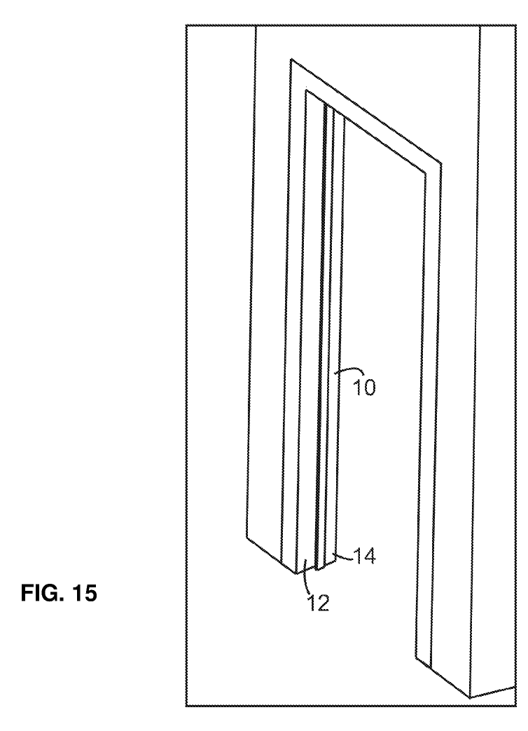

FIGS. 12 and 13 in step 4 and 5 shows the front 12 and back frame 14 fully joined and secured to the wall opening. FIG. 14 is a bottom view of a complete installed frame on the wall and FIG. 15 shows the installed door frame unit according to the present invention.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1- A prefabricated door frame to be installed in a door opening in a wall having a wall thickness, a front side and a back side, comprising:
a) an L-shaped front frame comprising of a front door jamb and a front door casing, having front corner joints, said front door jamb having a front-jamb-width, a front-jamb-thickness, a front-jamb-top-surface, and a front-inner-edge, said front-inner-edge having a front edge thickness that is smaller than said front-jamb-thickness;
b) a door stop attached to the front-iamb-top-surface close to said front-inner-edge, thereby forming a front-frame-groove on said front-jamb-edge;
c) an L-shaped back frame comprising of a back door jamb and a back door casing, having back corner joints, said back door jamb having a back-jamb-width, a back-jamb-thickness, a back-jamb-top-surface, and a back-inner-edge, said back-inner-edge having a back edge thickness that is smaller than said back-jamb-thickness, thereby forming a back-frame-tongue, and
d) a plurality of dowel joints in corner joints to support and maximize strength and rigidity of said door frame,
wherein said front frame and back frame are sized to fit in said door opening and securely maintained in a parallel relationship to each other, whereby said L-shaped front frame is installed on said front side, a reinforced foam is applied between said wall thickness and said front door jamb, then a second foam layer is applied and, thereafter said L-shaped back frame is installed on said back side, whereby said back-frame-tongue is received by said front-frame-groove.

2- The prefabricated door frame of claim 1, wherein said front-frame-groove and said back-frame-tongue are sized to provide a 5 to 8 inches of a total door jamb width, wherein said total door jamb width being the sum of front-jamb-width and the back-jamb-width.

3- The prefabricated door frame of claim 1, further having a plurality of dowels to secure said corner joints to provide substantial support to maintain the square orientation of the door casing and to maximize strength and rigidity to the frame.

4- The prefabricated door frame of claim 1, wherein said L-shaped front frame and said L-shaped back frame are made of plywood boards, wood boards, fiber boards, steel, or plastics.

5- The prefabricated door frame of claim 1, wherein said front-frame-groove and said back-frame-tongue are machine molded in a set of predefined dimensions to allow for wall thickness imperfections and variations within a range between 0 to 0.75 inches.

6- The prefabricated door frame of claim 1, wherein said door stop is an integral part of said front frame machined on said front-jamb close to said front-inner-edge so that said door stop overlaps said front-inner-edge.

7- The prefabricated door frame of claim 1, further having at least a door hinge to connect a door to said prefabricated door frame.

8- A method for installing a prefabricated door frame on a wall opening having a width, a front side and a back side, the method comprising the steps of:
obtaining a front-frame comprising of a front-door-jamb and a front-door-casing, said front-door-jamb having a front-jamb-width, a front-jamb-thickness, a front-jamb-top-surface, and a front-inner-edge, said front-inner-edge having a front-edge-thickness that is smaller than said front-jamb-thickness; a door-stop attached to the front-jamb-top-surface close to said front-inner-edge, thereby forming a front-frame-groove on said front-jamb-edge; a back-frame comprising of a back-door-jamb and a back-door-casing, said back-door-jamb having a back-jamb-width, a back-jamb-thickness, a back-jamb-top-surface, and a back-inner-edge, said back-inner-edge having a back-edge-thickness that is smaller than said back-jamb-thickness, thereby forming a back-frame-tongue;
mounting said front-frame on the front side of said wall opening;
adjusting the front-frame on the wall opening by inserting a set of thin shims in between the front-frame and the wall;
applying a first layer of reinforced foam in between the wall width and said front-door-jamb, wherein said first reinforced foam is squeezed and spread in between the wall width and said front-frame, and allowing for said reinforcement foam to dry;
applying a second layer of reinforced foam on the wall width, and
placing said back-frame on the back side of the wall opening and inserting said back-frame-tongue into said front-frame-groove to securely fit said prefabricated door frame on the door opening, while the second layer of reinforced foam is wet, and
allowing the second layer of reinforced foam to dry, thereby having a secure door frame.

9- The method of claim 8, further securing said front-frame and said back-frame on the wall using any one of nails, screws, or adhesives.
